(19) United States
(12) Patent Application Publication
(10) Pub. No.: US 2026/0250044 A1
(43) Pub. Date: Aug. 27, 2026

(54) FLAME MITIGATION SYSTEM AND METHOD OF MANUFACTURING SAME

(71) Applicant: BWAY CORPORATION, Oak Brook, IL (US)

(72) Inventor: William LaDon Hopkins, Pine Mountain, GA (US)

(21) Appl. No.: 19/547,116

(22) Filed: Feb. 23, 2026

Related U.S. Application Data
(60) Provisional application No. 63/761,848, filed on Feb. 21, 2025.

(51) Int. Cl. B65D 25/38; A62C 3/06; B65D 25/42

(52) U.S. Cl. CPC B65D 25/385; A62C 3/065; B65D 25/42

(57) ABSTRACT

A flame mitigator for a container includes a plurality of wire portions reticulated to define a plurality of spaces therebetween and form a body having a substantially dome-shaped profile extending along a longitudinal axis between a first end and an opposite second end, and a rim positioned adjacent the first end and defining an opening of the body. The plurality of spaces collectively provide an openness of the opening to inhibit flame propagation along a fluid stream from entering into the container. The flame mitigator further includes a projection extending radially outward from the rim and defining a periphery of the body, and a well extending radially inward and longitudinally away from the rim to the second end. The projection is elastically deformable and configured to deflect relative to the rim.

### CROSS-REFERENCE TO RELATED APPLICATIONS

This application claims priority to U.S. Provisional Patent Application No. 63/761,848, filed Feb. 21, 2025, the entire contents of which are incorporated herein by reference.

### FIELD

The present disclosure relates to flame mitigation systems. More particularly, the present disclosure relates to flame mitigation devices integrated into containers for holding and/or transporting flammable liquid.

### BACKGROUND

Flammable liquids, such as gasoline, kerosene, diesel fuel, alcohol‑based fuels, and/or the like are commonly stored and transported in portable containers. Flame propagation, specifically along a stream of such flammable liquid, can occur if a portion of the stream gets too close to an ignition source. These portable containers are often simple, low‑cost designs that provide only basic measures to reduce flame propagation.

### SUMMARY

One independent aspect of the present disclosure relates to a flame mitigator for a container including a plurality of wire portions reticulated to define a plurality of spaces therebetween and form a body having a substantially dome-shaped profile extending along a longitudinal axis between a first end and an opposite second end; a rim positioned adjacent the first end and defining an opening of the body, the plurality of spaces collectively providing an openness of the opening to inhibit flame propagation along a fluid stream from entering into the container; a projection extending radially outward from the rim and defining a periphery of the body, the projection being elastically deformable and configured to deflect relative to the rim; and a well extending radially inward and longitudinally away from the rim to the second end.

Another independent aspect of the present disclosure relates to a container including a container body including a bottom portion, a sidewall coupled to the bottom portion, and a top portion coupled to the sidewall, the bottom portion, the sidewall, and the top portion collectively defining an internal cavity configured to hold a flammable liquid; a spout coupled to the container body in fluid communication with the internal cavity, the spout including a mouth, a stem defining a flow passage between the mouth and the internal cavity, and an annular groove extending from the stem; and a flame mitigator positioned within the flow passage and including an elastically deformable reticular body having a substantially dome-shaped profile formed by a plurality of intersecting wires defining a plurality of spaces therebetween configured to permit liquid flow and inhibit flame propagation into the internal cavity, and a projection extending radially outward and received within the annular groove to mechanically couple the flame mitigator within the spout.

Still another independent aspect of the present disclosure relates to a method of manufacturing a container including providing a container body including a bottom portion, a sidewall portion, and a top portion, the top portion including an upper side exposed to an exterior of the container and an opposite lower side; positioning a spout on the upper side of the top portion, the spout including a stem, a mouth adjacent a first end of the stem, and an annular groove adjacent a second end of the stem opposite the first end; pressing, by a tool, a flame mitigator into the annular groove of the spout to mechanically couple the flame mitigator to the spout, the flame mitigator being elastically deformable and including a substantially dome-shaped profile, wherein a portion of the flame mitigator is deflected radially inwardly as the flame mitigator is pressed into the annular groove by the tool.

Other aspects of the present disclosure will become apparent upon consideration of the detailed description and accompanying drawings.

### BRIEF DESCRIPTION OF THE DRAWINGS

FIG. 1A is a perspective view of a container, according to an embodiment of the present disclosure.

FIG. 1B is a perspective view of an upper portion of the container of FIG. 1A, showing a pulled away top portion and a removed spout member.

FIG. 1C is an exploded perspective view of the spout member of FIG. 1B.

FIG. 2A is a perspective view of a container, according to another embodiment of the present disclosure.

FIG. 2B is a perspective view of an upper portion of the container of FIG. 2A, showing a pulled away top portion and a removed spout member.

FIG. 3 is an enlarged plan view of an example flame mitigator, taken at view arrow 3 of FIG. 1C.

FIG. 4 is a side sectional elevation of the flame mitigator of FIG. 3, taken at cutline 4-4.

FIG. 5 is an enlarged side sectional elevation of the flame mitigator having tamper-proof capability.

FIG. 6 is a side sectional elevation of the flame mitigator having varied example dimensions, taken at cutline 6-6 of FIG. 2B.

FIG. 7 is a local side sectional elevation of the spout member and the container of FIG. 1A, taken at cutline 7-7, with a portion thereof removed to show liquid within the container.

FIG. 8 is a side sectional elevation of the spout member shown in FIG. 7.

FIG. 9 is a local side sectional elevation of another spout member, having tamper-proof capability, and the container of FIG. 1A, taken at cutline 7-7, with a portion thereof removed to show liquid within the container.

FIG. 10 is a side sectional elevation of the spout member shown in FIG. 9.

FIG. 11 is a side sectional elevation of the spout member and the container of FIG. 2A, with a portion thereof removed to show liquid within the container.

FIG. 12 is a side sectional elevation of the spout member of FIG. 11, taken at cutline 12-12 of FIG. 2A.

FIG. 13 is a side elevation view in partial section, showing a step for assembling the container of FIG. 1A, illustrating a tool introducing the flame mitigator of FIG. 3 into the spout member of FIG. 8, taken at view arrow 13 of FIG. 8.

FIG. 14 is a local side elevation in partial section, showing another step progressing beyond FIG. 13, illustrating the tool seating/securing the flame mitigator into the spout member.

FIG. 15 is a side elevation view in partial section, showing a step for assembling the container of FIG. 1A, illustrating a tool introducing the flame mitigator of FIG. 5 into the tamper-proof capable spout member of FIG. 10, taken at view arrow 15 of FIG. 10.

FIG. 16 is a local side elevation in partial section, showing another step progressing beyond FIG. 15, illustrating the tool seating/securing the flame mitigator into the spout member.

FIG. 17 is a side elevation view in partial section, showing a step for assembling the container of FIG. 2A, illustrating a tool introducing the flame mitigator of FIG. 6 into the spout member of FIG. 12, taken at view arrow 17 of FIG. 12.

FIG. 18 is a local side elevation in partial section, showing another step progressing beyond FIG. 17, illustrating the tool seating/securing the flame mitigator into the spout member.

### DETAILED DESCRIPTION

The following description includes examples of the disclosed technology. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and methods described because the relevant teachings can be applied or practiced in a variety of ways. The terminology and nomenclature used herein is for the purpose of describing particular aspects only and is not intended to be limiting. In general, well-known structures or techniques are not necessarily shown in detail.

The disclosed technology will be described more fully hereinafter with reference to the accompanying drawings. This disclosed technology can, however, be embodied in many different forms and should not be construed as limited to the examples set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

In the following description, numerous specific details are set forth. But it is to be understood that examples of the disclosed technology can be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

To the extent any aspects of the disclosed technology are presented in a range of formats (e.g., a range of values), it is to be understood that such descriptions are merely for convenience and brevity and should not be construed as an inflexible limitation on the scope of the disclosed technology. Accordingly, the description of a range should be considered to have specifically disclosed all the possible subranges as well as individual rational numerical values within that range. For example, a range described as being “from 1 to 6” or “from approximately 1 to approximately 6” includes the values 1, 6, and all values therebetween. Likewise, a range described as being “between 1 and 6” or “between approximately 1 and approximately 6” includes the values 1, 6, and all values therebetween. The same premise applies to any other language describing a range of values. That is to say, any ranges disclosed herein are inclusive of the respective endpoints, unless otherwise indicated.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential.

The terms “approximately” and “about,” as used herein, refer to slight variations of the specified values. These variations may occur due to manufacturing tolerances, measurement limitations, or inherent variability in conditions, and should be understood to allow for a reasonable margin of error that would not materially affect the disclosed technology or its operation. Unless otherwise indicated, such terms generally encompass a range of ±10% of the referenced value.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described should be in a given sequence, either temporally, spatially, in ranking, or in any other manner.

Additional objects, advantages, and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the illustrative examples provided in the drawings, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

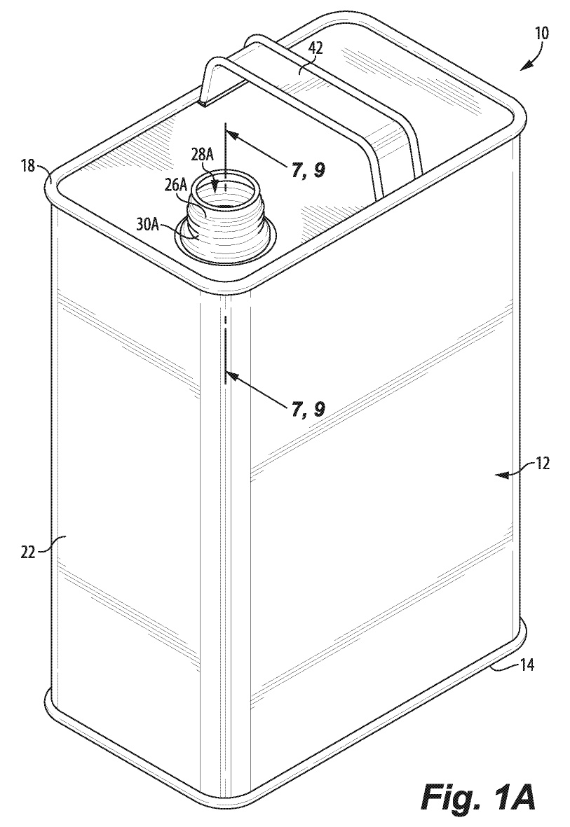

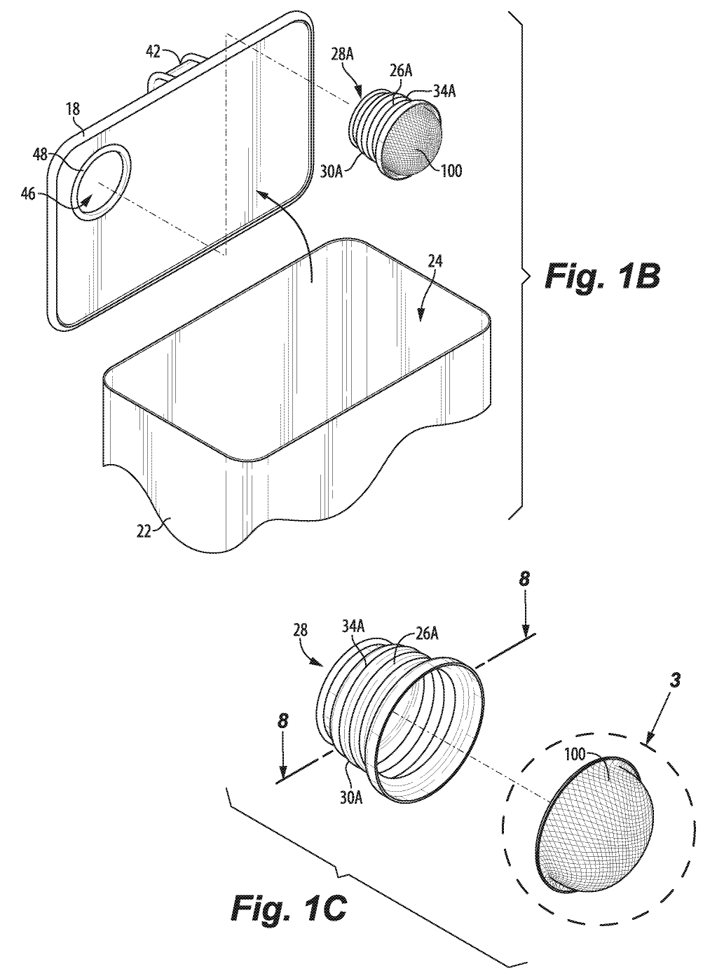

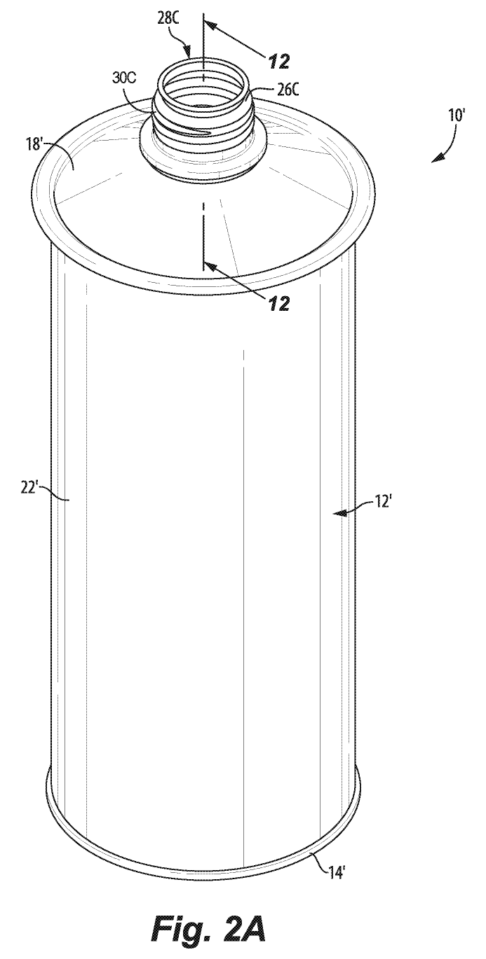

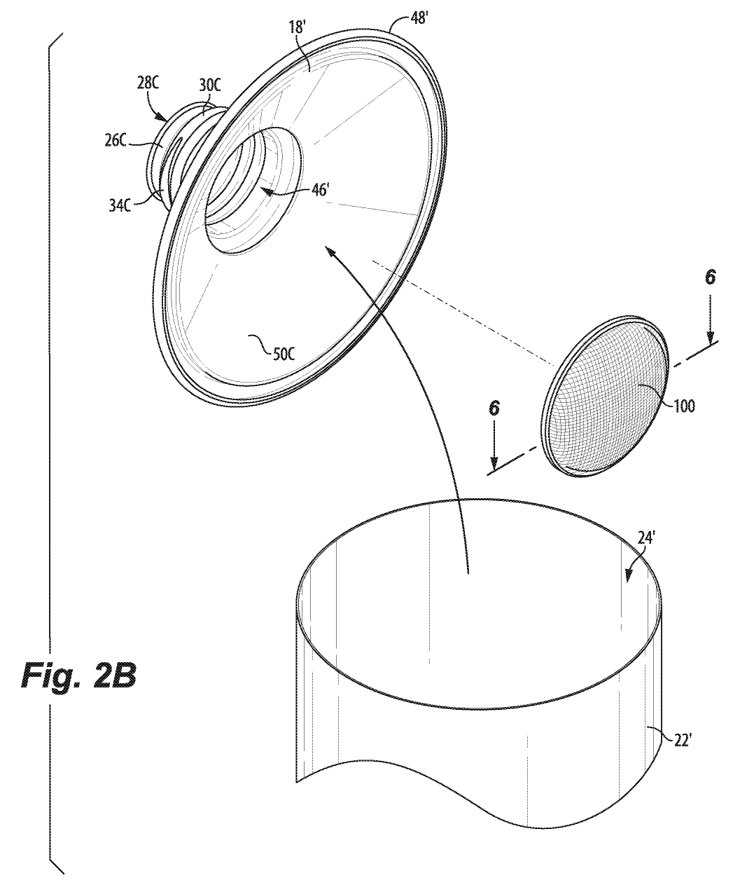

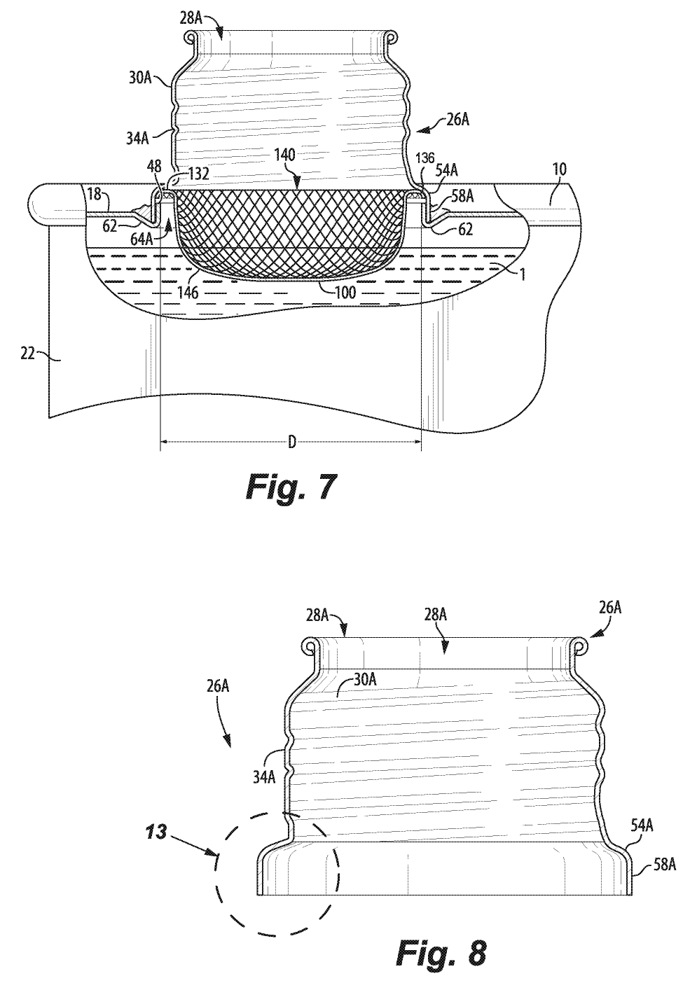

FIGS. 1A and 2A of the present disclosure respectively illustrate first and second containers 10, 10’ that may be portable containers configured to store flammable fluids, primarily flammable liquids 1 (FIGS. 7, 9, and 11), such as gasoline, kerosene, diesel, ethanol, methanol, denatured alcohol, biofuel, and/or the like. The first container 10 and the second container 10’ share similar features that are presently given the same reference number, with the inclusion of a “ ’ ” to denote features of the second container 10’.

Referring to FIGS. 1A-1C, the first container 10 is an F-Style can, typically made of metal (e.g., tin, steel, tin-plated steel, etc.) and ranging in size and capacity (e.g., pint, quart, gallon, etc.). In some instances, the first container 10 could be a jerrycan, military can, and/or the like, with a capacity ranging from a single gallon to more than twenty gallons. Similarly, as illustrated in FIG. 2A, the second container 10’ is a round cone-top can, also typically made of metal as defined above and ranging in size and capacity. In general, the first container 10 and the second container 10’ are each portable and usable for a number of purposes, including, but not limited to, transporting, storing, and/or dispensing flammable materials, particularly flammable liquids.

With continued reference to FIGS. 1A-2B, the first container 10 and the second container 10’ each include a container body 12, 12’ having a first portion (i.e., a bottom portion 14, 14’), a second portion (i.e., a top portion 18, 18’), and a third portion (i.e., a sidewall 22, 22’) extending between the bottom portion 14, 14’ and the top portion 18, 18’. As best illustrated in FIGS. 1B and 2B, the bottom portion 14, 14’, the top portion 18, 18’, and the sidewall 22, 22’ may collectively define an internal cavity 24, 24’.

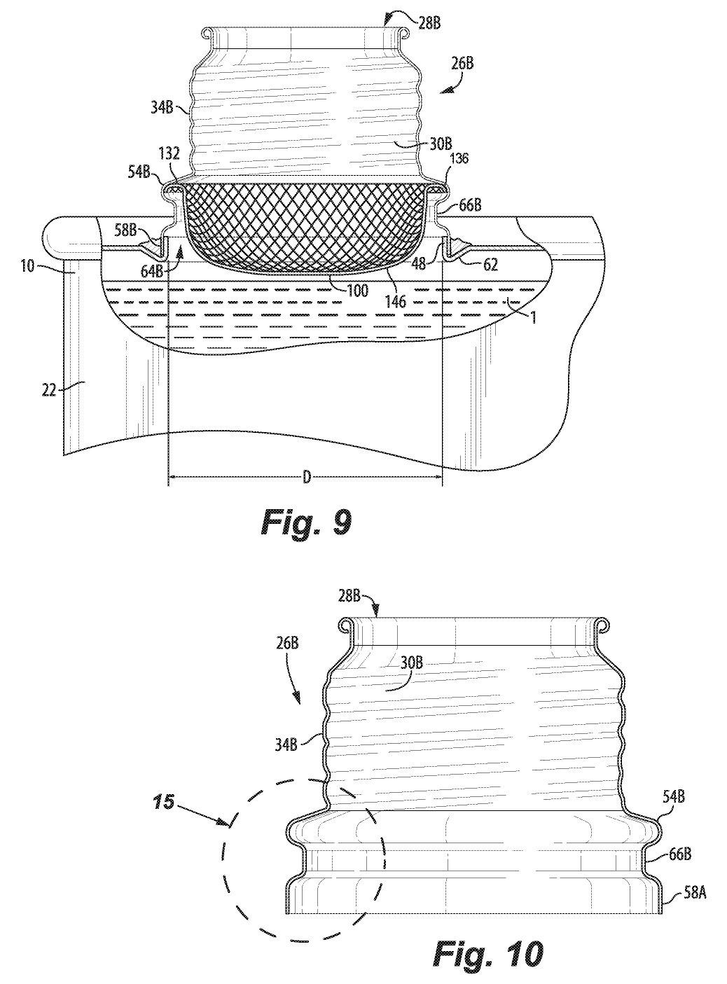

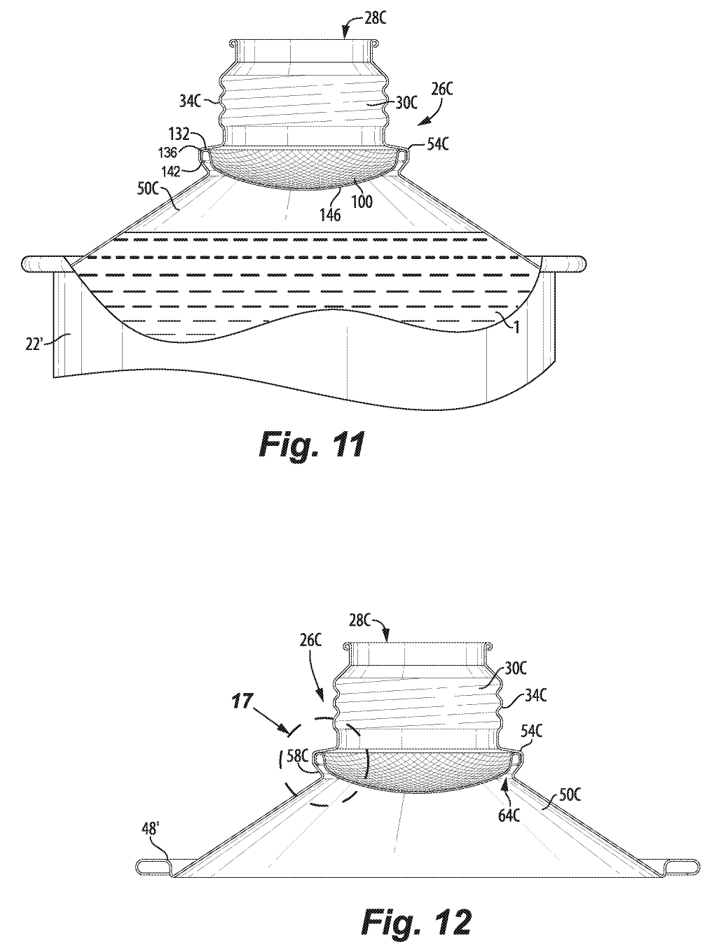

As a brief introduction to FIGS. 7-12, a body, such as spout, nozzle, or the like, may be coupled to the top portion 18, 18’. Moving forward, the body may be a first spout 26A according to a first example construction illustrated in FIGS. 7-8, a second spout 26B according to a second example construction illustrated in FIGS. 9-10, or a third spout 26C according to a third example construction illustrated in FIGS. 11-12. The first spout 26A, the second spout 26B, and the third spout 26C share similar features that are presently given the same reference numbers, with the inclusion of an “A,” “B,” or “C” to denote relative features. Differences between the first spout 26A, the second spout 26B, and the third spout 26C are explained in detailed herein.

Referring back to FIGS. 1A-2B, the first spout 26A, the second spout 26B, and the third spout 26C each include (e.g., integrally formed with or coupled to) a mouth 28A, 28B, 28C (e.g., opening, outlet, etc.) through which liquid may pass (e.g., when being inserted into and/or dispensed from the internal cavity 24, 24’). Generally, the mouth 28A, 28B, 28C is provided on a neck or stem 30A, 30B, 30C that supports threads 34A, 34B, 34C designed to receive and secure a threaded stopper (e.g., cap), which may be selectively coupled to the mouth 28A, 28B, 28C to close the container 10, 10’ (e.g., to seal the internal cavity 24, 24’, cover the mouth 28A, 28B, 28C, etc.). In some instances, the threads 34A, 34B, 34C are omitted, and the stem 30A, 30B, 30C includes another type of finish (e.g., bayonet, countersink, flush wall, etc.) to receive another type of stopper (e.g., plug, cork, seal, etc.).

Referring briefly back to FIGS. 1A and 1B, the first container 10 may also include a handle 42 coupled to and/or formed integrally with the top portion 18 and/or the sidewall 22. In some instances, typically for containers having lower capacities, the handle 42 may be omitted.

Referring now to FIGS. 1B, 1C, and 2B, a device, such as a flame mitigator 100, may be coupled to the first container 10 and/or the second container 10’ and positioned adjacent the internal cavity 24, 24’, such that the flame mitigator 100 is generally not visible to a user during operation (e.g., filling, dispensing, pouring, etc.) of the container 10, 10’. In some example constructions, the flame mitigator 100 may be coupled to the first spout 26A, the second spout 26B, and/or the third spout 26C. One example purpose of the flame mitigator 100, as detailed further below, is to inhibit flame propagation along a fluid stream into the internal cavity 24, 24’.

In some instances, the flame mitigator 100 may be referred to as a flame mitigation device (“FMD”), a flame arrestor, a fire inhibitor, a fire safety device, or the like. Another example purpose of the flame mitigator 100 is to filter fluid being dispensed into the internal cavity 24, 24’ (e.g., to inhibit debris from mixing with any fluid within the container 10, 10’). It should be understood that the flame mitigator 100 may be implemented on any container, particularly a container having a single opening for filling and dispensing. That is, the container may be of any shape, such as the container 10 of FIG. 1A, which has a generally rectangular prismatic shape, or the container 10’ of FIG. 2A, which has a generally cylindrical shape. It should further be appreciated that the term “container” is not exclusive to the first container 10 and the second container 10’, nor to only portable containers.

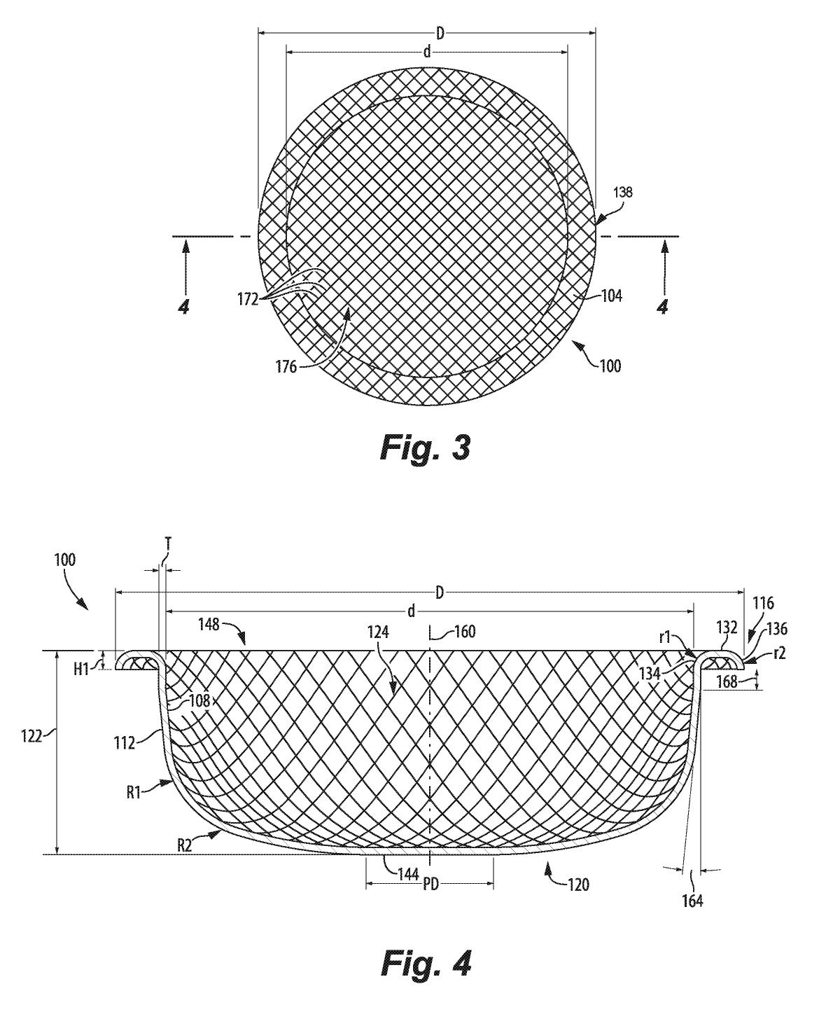

Referring specifically now to FIGS. 3-6, the flame mitigator 100 may be made (e.g., formed, composed, and/or comprised) of a material suitable to withstand corrosion caused by contact with the fluids and/or liquids discussed herein. In the illustrated embodiment, the flame mitigator 100 is made of a metallic alloy, such as stainless steel (e.g., 304 stainless steel), aluminum, titanium, copper, bronze, nickel, and/or the like. The flame mitigator 100 includes a reticular body 104 (e.g., mesh, net, lattice, etc.), and in some instances, different portions of the reticular body 104 may be made of different materials.

In the illustrated embodiment, the reticular body 104 has a dome or bowl shape (e.g., substantially semi-circular). In other example constructions, the reticular body 104 may have another shape, such as a polygonal, elongated, substantially spherical, generally hemispherical, and/or planer shape. In some instances, the reticular body 104 has an irregular shape and/or profile (e.g., having a semi-circular portion and a polygonal portion). In all, the shape of the reticular body 104 may help permit liquid to easily flow into or out of the container 10, 10’ while also reducing or inhibiting splash back.

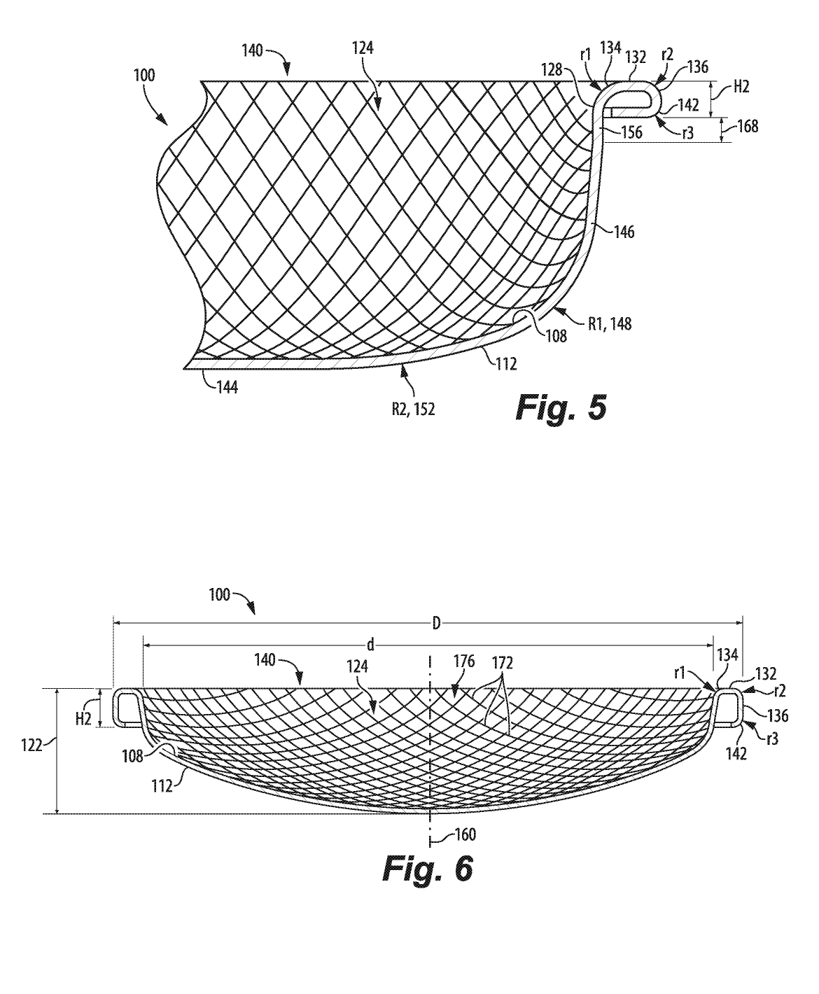

The reticular body 104 further includes a first surface 108 and a second surface 112 opposite the first surface 108. In the illustrated embodiment, the first surface 108 has a substantially concave profile, and the second surface 112 has a substantially convex profile that generally extends towards the internal cavity 24, 24’ of the container 10, 10’. Simply for reference, the first surface 108 may be a surface through which fluid passes first during the filling process, while the second surface 112 may be a surface through which fluid passes first during the dispensing process. Relatedly, the reticular body 104 includes a first end 116 and an opposite second end 120, which is, in one example construction, closer to the internal cavity 24, 24’ than the first end 116 (e.g., the second end 120 may be positioned between the first end 116 and the internal cavity 24, 24’). In one instance, a distance 122 between the first end 116 and the second end 120 is between approximately 0.620 inches and approximately 0.220 inches. For example, the distance 122 illustrated in FIGS. 4 and 5 may be approximately 0.420 inches. In another instance, the distance 122 is between approximately 0.420 inches and approximately 0.020 inches. For example, the distance 122 illustrated in FIG. 6 may be approximately 0.220 inches.

The reticular body 104 even further includes a well 124 defined by the first surface 108 and terminated by a rim 128, which is positioned adjacent the first end 116. The rim 128 may, in some instances, include a projection 132, such as lip, brim, prong, or the like. It should be noted that different shapes and/or configurations of the rim 128 and the projection 132 are contemplated. For example, the rim 128 may include an interior bevel 134 (e.g., transition curve, arc, slope, bend, fold, etc.) that is defined by a first minor radius r1. Similarly, the projection 132 may also include an upper exterior bevel 136 that is defined by a second minor radius r2. In some example constructions, such as in the embodiments illustrated in FIGS. 5 and 6, the projection 132 may also include a lower exterior bevel 142 that is defined by a third minor radius r3. In such embodiments, the projection 132 extends beyond the lower exterior bevel 142 in a direction toward the well 124. In some examples, the lower exterior bevel 142 is formed by the projection 132 being folded on itself to provide additional structural integrity to the projection 132.

In one instance, the first minor radius r1 may be between approximately 0.025 inches and approximately 0.100 inches. For example, the first minor radius r1 may, as illustrated in FIGS. 4 and 5, be approximately 0.050 inches. In the same or another instance, the second minor radius r2 may be between approximately 0.015 inches and approximately 0.060 inches. For example, the second minor radius r2 may, as illustrated in FIG. 4, be approximately 0.050 inches, and as illustrated in FIG. 5, be approximately 0.030 inches. In still the same or yet another instance, the third minor radius r3 may be between approximately 0.010 inches and approximately 0.030 inches. For example, the third minor radius r3 may, as illustrated in FIGS. 5 and 6, be approximately 0.020 inches.

Relating still to the rim 128 and the projection 132, the interior bevel 134 and the upper exterior bevel 136, as illustrated in FIG. 4, may fit within a first height H1. Similarly, the interior bevel 134, the upper exterior bevel 136, and lower exterior bevel 142, as illustrated in FIGS. 5 and 6, may fit within a second height H2. In one instance, the first height H1 may be between approximately 0.050 inches and approximately 0.090 inches. For example, the first height H1 may, as illustrated in FIG. 4, be approximately 0.070 inches. In the same or another instance, the second height H2 may be between approximately 0.075 inches and approximately 0.035 inches. For example, the second height H2 may, as illustrated in FIGS. 5 and 6, be approximately 0.055 inches.

As illustrated in FIG. 3, the reticular body 104 may have a major diameter D and a minor diameter d, where the major diameter D is taken (e.g., measured, projected, etc.) across a periphery 138 (e.g., outer most edge) of the reticular body 104, and the minor diameter d is taken across an opening 140 of the well 124, which is here defined at a plane where the rim 128 transitions to the first surface 108 (e.g., where portions of the reticular body bchange from horizontal to vertical).

In one embodiment, the major diameter D may be between approximately 1.5 inches and approximately 1 inch. In other embodiments, the major diameter D may be between approximately 1.3125 inches and approximately 1.25 inches, with an accepted tolerance of plus or minus approximately 0.010 inches. In the illustrated embodiment of FIGS. 3 and 4, the major diameter D is approximately 1.285 inches with a tolerance of plus approximately 0.002 inches and minus approximately 0.001 inches. In the illustrated embodiment of FIG. 5, the major diameter D is approximately 1.28125 inches with a tolerance of plus approximately 0.002 inches and minus approximately 0.001 inches. In the illustrated embodiment of FIG. 6, the major diameter D is approximately 1.354 inches with a tolerance of plus approximately 0.010 inches and minus approximately 0.010 inches.

In one embodiment, the minor diameter d may be between approximately 1.25 inches and approximately 0.5 inches. In other embodiments, the minor diameter d may be between approximately 1.109375 inches and approximately 0.0625 inches, with an accepted tolerance of plus or minus approximately 0.002 inches. In the illustrated embodiment of FIGS. 3-5, the minor diameter d is approximately 1.076 inches with a tolerance of plus approximately 0.002 inches and minus approximately 0.001 inches. In the illustrated embodiment of FIG. 6, the minor diameter d is approximately 1.294 inches with a tolerance of plus approximately 0.020 inches and minus approximately 0.020 inches.

Although potentially perceived as a substantially perfect dome or bowl, some example constructions of the reticular body 104 may include a base 144 that is not curved by the same amount as the rest of the reticular body 104 or that is not curved at all (e.g., a portion that is level, flattened, plateaued, etc.). For example, as illustrated in FIGS. 3 and 4, the reticular body 104 includes a base 144 that is substantially flattened yet still circular. In such example, the base 144 may have a proportionate diameter PD that is complementary to the major diameter D and the minor diameter d of the reticular body 104.

In the illustrated embodiment, according to one example construction, the proportionate diameter PD may be between approximately 0.40 inches and approximately 0.05 inches. In some embodiments, the major diameter D is approximately 1.28125 inches and the proportionate diameter PD is between approximately 25% (0.32125 inches) and approximately 10% (0.1285 inches) of the major diameter D. In the illustrated embodiment, the proportionate diameter PD of the flattened base 144 is approximately 0.25 inches. It should be understood that although the illustrated flattened base 144 is centralized, any portion of the reticular body 104 may include a non-curved portion (e.g., flattened part).

With continued referend to FIGS. 4-6, the well 124 is defined by an irregularly (e.g., non-uniformly) curved wall 146 (e.g., having portions that are curved, rounded, bowed, and/or the like). The wall 146 extends from the rim 128 in a direction towards the second end 120 and may include multiple distinct segments or parts, including a first portion 148 having a first radius R1, a second portion 152 having a second radius R2, a leg 156 that is substantially linear, and the base 144. That is, the wall 146 may be considered curvilinear because it includes and/or is bounded by curved and non-curved (e.g., flat, linear, etc.) segments. The wall 146 may also include a wall thickness T between approximately 0.030 inches and approximately 0.005 inches. In some instances, the wall thickness T may be between approximately 0.020 inches and approximately 0.012 inches. The illustrated wall thickness T is, in one example instance, approximately 0.0157 inches.

In some embodiments, the first radius R1 may be between approximately 0.05 inches and approximately 0.35 inches (e.g., approximately 0.20 inches). In some embodiments, the second radius R2 may be between approximately 1.0 inches and approximately 0.65 inches (e.g., approximately 0.87 inches). In some example arrangements, such as in the embodiment illustrated in FIG. 6, the wall 146 may have a nominally sized or omitted base 144, such that one of the first radius R1 and the second radius R2 is substantially or significantly larger than the other. In such arrangement, the first radius R1 may be between approximately 0.75 inches and approximately 0.25 inches (e.g., approximately 0.50 inches), and the second radius R2 may be between approximately 0.05 inches and approximately 0.35 inches (e.g., approximately 0.20 inches).

In one embodiment, as illustrated best in FIG. 4, the leg 156 is angled relative to a longitudinal axis 160 of the base 144 and/or reticular body 104 by an angle 164. In some embodiments, the angle 164 is between approximately 15 degrees and approximately 2 degrees (e.g., approximately 5 degrees). The leg 156 also extends from the rim 128 with a length 168. In one example construction, the length 168 is between approximately 0.02 inches and approximately 0.06 inches (e.g., approximately 0.04 inches). In some instances, the length 168 is measured between the rim 128 and a start of the first portion 148 and/or the second portion 152. Stated differently, the leg 156 may transition into a curved section having the first radius R1 and/or second radius R2.

Referring specifically to FIG. 3, the reticular body 104 is formed by a network of overlapping (e.g., reticulated, crisscrossed, latticed, etc.) wire portions 172 with spaces 176 therebetween. In the illustrated embodiment, the wire portions 172 are reticulated and/or joined to define the reticular body 104 as a unitary structure. In one example instance, the flame mitigator 100 consists of the wire portions 172 assembled together and manipulated into a desired shape. In one example instance, the spaces 176 are dimensioned to sufficiently reduce flame mitigation into the container 10, 10’ without critically impacting the container’s 10, 10’ usability. For example, the spaces 176 provide protection while allowing liquid to pass through the reticular body 104 during operation of the container 10, 10’. More specifically, aspects of the reticular body 104, as described below, define a flow rate that incorporates a liquid flow capacity – during filling or dispensing, a flame mitigation rate, and a fluid vent rate. In one example instance, the liquid flow capacity may be between approximately 3.40 gallons (~435.20 fluid ounces) and approximately 4.60 gallons (~588.80 fluid ounces) per approximately every sixty seconds. In the illustrated embodiment, the liquid flow capacity may be approximately 4.1 gallons (~524.80 fluid ounces) per every sixty seconds.

Aspects and/or features of the reticular body 104 that influence the flow rate, with continued reference to FIG. 3, include, among other things, a size and shape of the spaces 176 (e.g., spacing), overall dimensions of the reticular body (e.g., major diameter D, height H, etc.), a density and/or diameter of the wire portions 172 (e.g., wire gauge), and/or a shape of the reticular body 104. In some example arrangements, the spaces 176 are uniform throughout the reticular body 104. In some instances, however, the spaces 176 may have differing relative sizes (e.g., the spaces 176 can vary throughout the reticular body 104 between adjacent smaller or larger wire portions 172). In some embodiments, the spaces 176 are substantially polygonal. In the illustrated embodiment, the spaces 176 are substantially square.

In some instances, the spaces 176 have a length and width between approximately 0.02 inches and approximately 0.05 inches. In the illustrated embodiment, the spaces 176 have a length and width of approximately 0.0331 inches (~850.0 micrometers). In another example arrangement, the spaces 176 have a length and width of approximately 0.034 inches (~863.6 micrometers). The size and number of spaces 176 may also be defined and/or impacted by the diameter of the wire portions 172, which generally corresponds to the thickness T of the wall 146, as discussed above. In some scenarios, the illustrated spaces 176 would qualify the reticular body 104 as having a No. 20 mesh (e.g., medium-sized mesh), as defined by the United States Standard Testing Sieve (ASTM E11). It should be understood, however, that in some scenarios the spaces 176 could be sized to qualify the reticular body 104 as having a small-sized mesh or a large-sized mesh.

Inherent to the size and number of spaces 176 is a flame mitigation rate corresponding to an openness of the flame mitigator 100, where 0% open would define completely covered surface, and 100% open would define completely uncovered surface. In one instance, the wire portions 172 and the spaces 176 cause the flame mitigator 100, specifically the opening 140, to be between approximately 41% open and approximately 51% open, between approximately 44% open and approximately 48% open, or another range of openness. In the illustrated embodiment, the opening 140 is approximately 46.2% open. In other words, the reticular body 104 blocks 53.8% of the opening 140.

For background, the “openness” of the flame mitigator 100 can be of interest because it affects the balanced protection and flow rate discussed above. For example, if the opening 140 is too closed or constricted, an adequate fill rate cannot be achieved, whereas if the opening 140 is not closed or constricted enough, the flame mitigator 100 cannot provide adequate fire protection. In the illustrated embodiment, the openness is configured to allow fluid flow while simultaneously inhibiting flame propagation.

Referring now to FIGS. 7-12, as stated above, the first spout 26A, the second spout 26B, and the third spout 26C share similar features that are presently given the same reference number, with the inclusion of an “A,” “B,” or “C” to denote relative features. For example, each of the first spout 26A, the second spout 26B, and the third spout 26C includes a respective mouth 28A, 28B, 28C, a stem 30A, 30B, 30C, and threads 34A, 34B, 34C. The stem 30A, 30B, 30C may provide or define a flow passage between the mouth 28A, 28B, 28C and the internal cavity 24, 24’. In the illustrated example arrangements, the first spout 26A, the second spout 26B, and the third spout 26C also each include a lower annular groove 54A, 54B, 54C terminated by a skirt 58A, 58B, 58C. In some instances, the skirt 58A, 58B, 58C extends radially around the entire stem 30A, 30B, 30C. In other instances, however, the skirt 58A, 58B, 58C extends radially around a portion of the stem 30A, 30B, 30C.

In a general sense, the flame mitigator 100 may be coupled to the first spout 26A, the second spout 26B, and/or the third spout 26C within the flow passage. In other words, fluid passes through the flame mitigator 100 to exit the container 10, 10’. During a coupling operation, as detailed below, the rim 128, particularly the projection 132, is flexed elastically inward in order to pass beyond the skirt 58A, 58B, 58C and spring outward into the lower annular groove 54A, 54B, 54C. Stated differently, the rim 128, projection 132, and/or entire reticular body 104 is elastically deformable. In this sense, the flame mitigator 100 may be mechanically coupled to the container 10, 10’ and seated/secured therein without additional joining—as defined above—needed beyond the material elasticity of the flame mitigator 100.

With specific reference to FIGS. 7-10, the first container 10 further includes a countersink portion 62 formed in the top portion 18. The countersink portion 62 is dimensioned to receive the skirt 58A, 58B and facilitate coupling of the first spout 26A or second spout 26B to the first container 10. In some instances, the countersink portion 62 is formed by the shoulder 48, 48’. In the illustrated embodiments, the skirt 58A, 58B fits over an outer part of the countersink portion 62. As such, the countersink portion 62 forms a constriction 64A, 64B that is sized to be slightly smaller than the major diameter D of the flame mitigator 100, while the lower annular groove 54A, 54B, 54C is sized to be approximately the same as or minimally smaller than the major diameter D. Regarding the second container 10’, a revolute flange 50C may extend from the skirt 58C and form part or all of a constriction 64C.

Referring specifically to FIGS. 9 and 10, the second spout 26B may further include a bead 66B between the lower annular groove 54B and the skirt 58B. In some example instances, the bead 66B is considered a tamper bead positioned to provide evidence or tampering done to the flame mitigator 100. For example, if the flame mitigator 100 is pressed out the lower annular groove 54B, the projection 132 will bear heavily against the bead 66B to critically deform of the projection 132, thus leaving evidence of tampering, even if the flame mitigator 100 were forced back into the second spout 26B.

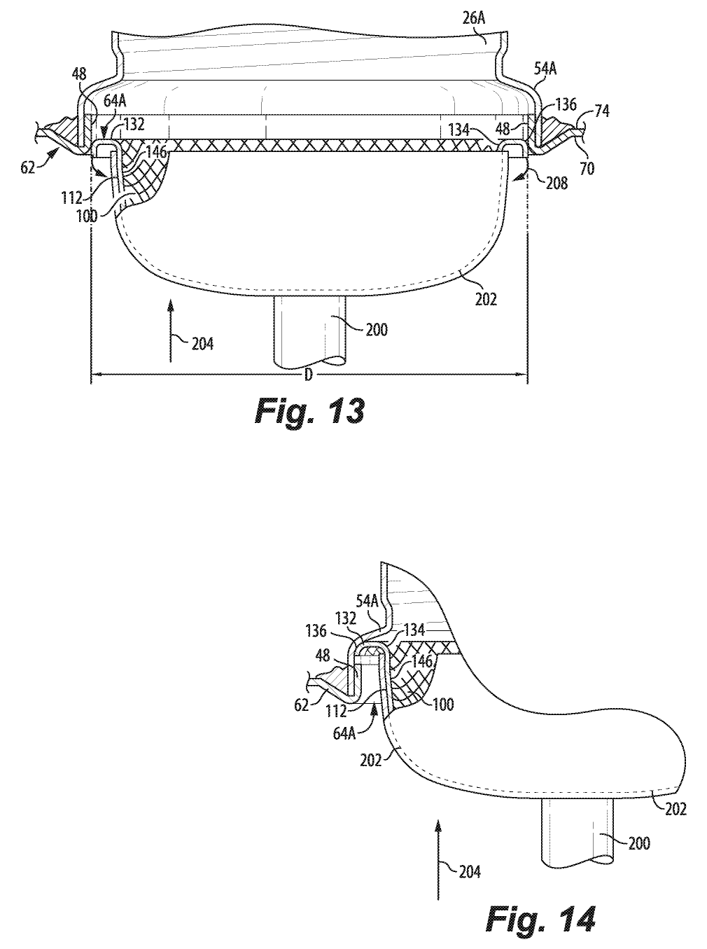

As will be made relevant below, the constriction 64A, 64B, 64C of the first spout 26A, the second spout 26B, and the third spout 26C provides clearance for a tool 200 (FIGS. 13-18), or portion thereof, to fit between the wall 146 of the flame mitigator 100 and the skirt 58A, 58B, 58C and/or container 10, 10’. Further, the constriction 64A, 64B, 64C may have a generally open bottom. In one example arrangement, the tool 200 bears against the wall 146, specifically below the projection 132, to press the flame mitigator 100 upwardly into the first spout 26A/second spout 26B/third spout 26C. In some instances, the tool 200 may be a pneumatic piston, spindle, mandrel, and/or the like. Further still, the tool 200 includes an output profile 202 that may have a bowl or dome shape complementary to the shape of the flame mitigator 100 (e.g., well 124, wall 146, etc.).

Referring briefly back to FIGS. 1A-2B, during manufacturing of either the first container 10 or the second container 10’, the bottom portion 14, 14’ may be coupled to the sidewall 22, 22’ via a joining process, such as welding, crimping, or the like. Alternatively, the bottom portion 14, 14’ and the sidewall 22, 22’ may be provided as a single piece and formed accordingly (e.g., stamping, molding, casting, etc.). In one example method of manufacturing the first container 10 or the second container 10’, as exemplified in FIGS. 1B and 1C, the top portion 18, 18’ is formed separately from the bottom portion 14, 14’ and the sidewall 22, 22’ and later coupled thereto. Before the top portion 18, 18’ is joined therewith, however, a hole 46, 46’ may be formed (e.g., stamped, cut out, etc.) in the top portion 18, 18’.

After the hole 46, 46’ is formed but before the top portion 18, 18’ is coupled to the bottom portion 14, 14’ and/or the sidewall 22, 22’, a shoulder 48, 48’ may be formed in the top portion 18, 18’ to support mounting and securing of the first spout 26A, the second spout 26B, or the third spout 26C in the hole 46, 46’. In some embodiments, the first spout 26A, the second spout 26B, and/or the third spout 26C are secured in the hole 46, 46’ via welding, crimping, or another mechanical coupling method.

In an alternate example method of manufacturing the first container 10 or the second container 10’, the top portion 18, 18’ is formed monolithically as a single piece with the mouth 28A, 28B, 28C, the stem 30A, 30B, 30C, and the threads 34A, 34B, 34C. In one such instance, for example, as illustrated in FIGS. 2B and 7, the second container 10’ includes the revolute flange 50C coupled to the mouth 28A, 28B, 28C, the stem 30C, and the threads 34C (FIG. 2B), where the revolute flange 50C is also positioned on the third spout 26C (FIG. 7). Stated differently, in the above described example instance, the revolute flange 50C of the third spout 26C is joinable directly to the sidewall 22’, such that the third spout 26C forms the top portion 18’ of the second container 10’.

Referring now to FIGS. 13-18, the tool 200 may be operated along a tool axis 204 between a first position (FIGS. 13, 15, 17), in which the projection 132 of the flame mitigator 100 begins to deflect radially inwardly and downwardly (shown by arrow 208), relative to the wall 146, and a second position (FIGS. 14, 16, 18), in which the projection 132 is allowed to elastically snap back from being deformed. Once the projection 132 “snaps back” it is considered mechanically coupled. Further, the tool 200 may be operated from below the top portion 18, 18’, specifically adjacent a lower side 70, 70’ of the container 10, 10’. Inherently, the top portion 18, 18’ includes an upper side 74, 74’ opposite the lower side 70, 70’.

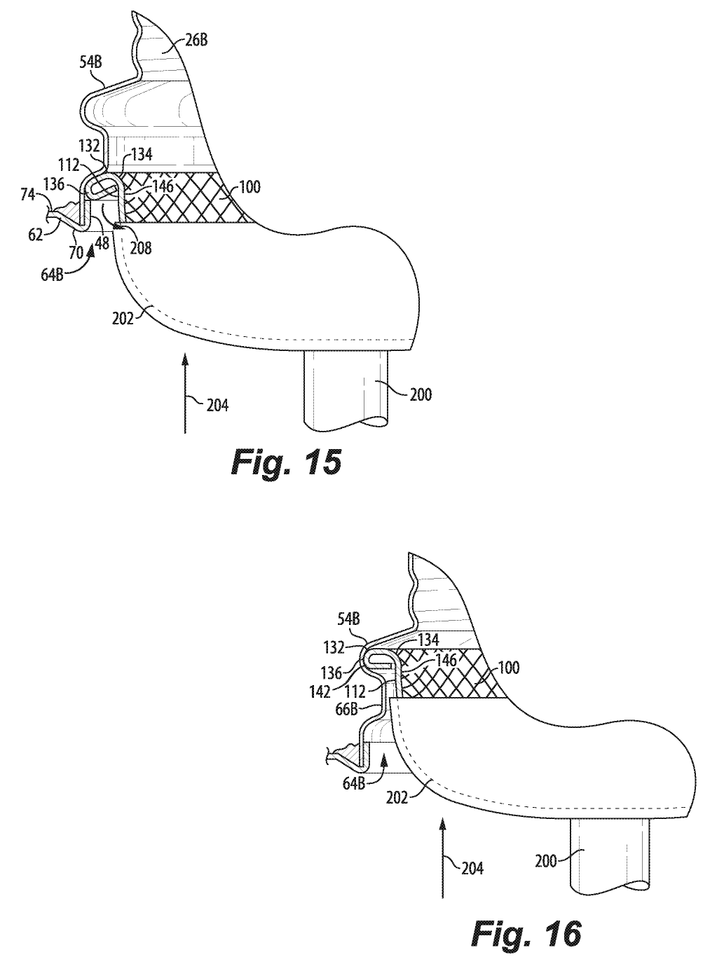

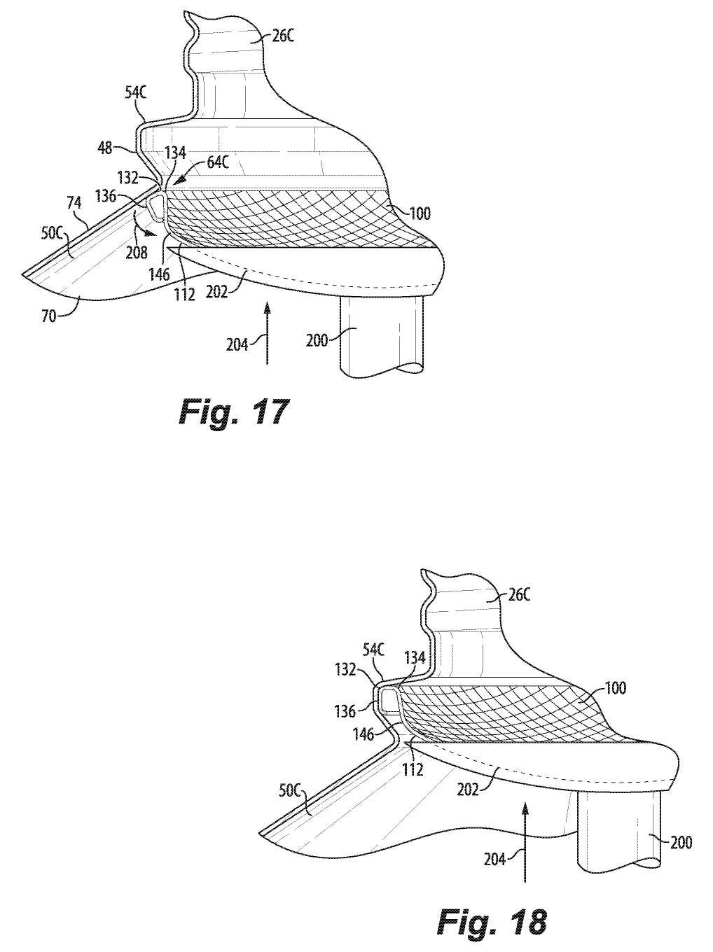

Specifically, when in the first position illustrated in FIGS. 13 and 15, the upper exterior bevel 136 of the flame mitigator 100 slidably bears against the shoulder 48 provided in the countersink portion 62 at the constriction 64A, 64B. As the tool 200 continues to move upwardly along the tool axis 204, the projection 132 deflects radially inward by a greater amount until the projection 132 longitudinally clears the shoulder 48. Similarly, when in the first position illustrated in FIG. 17, the upper exterior bevel 136 of the flame mitigator 100 slidably bears against the revolute flange 50C until the projection 132 deflects radially inward and longitudinally clears the constriction 64C.

When in the second position illustrated in FIGS. 14, 16, and 18, the projection 132 contacts the lower annular groove 54A, 54B, 54C in a substantially or totally non-deformed state. Further, when in the second position, the tool 200 may fit between the flame mitigator 100 and the spout 26A, 26C, 26C and/or between the flame mitigator 100 and the container 10, 10’. Stated differently, although the constriction 64A, 64B, 64C tightens a space through which the flame mitigator 100 passes, the tool 200 may fully seat the flame mitigator 100 and be subsequently removed.

The output profile 202 of the tool 200 generally contacts a majority of the second surface 112 to provide an evenly distributed and comprehensive load to the flame mitigator 100 during insertion. In some instances, the profile 202 extends into an inner-most part of the projection 132. During tool 200 operation, as a non-limiting example, the projection 132 can be pressed upwardly along the tool axis 204 against the shoulder 48 and/or revolute flange 50C with a first force needed to initiate deflection of the projection 132. Once mechanical coupling is achieved, the flame mitigator 100 may withstand a second downward force before being dislodged (e.g., unseated, separated, uncoupled, etc.) from its seat within the lower annular groove 54A, 54B, 54C. In some examples, the second force is between approximately forty pounds per square inch and approximately ten pounds per square inch. In another example, the second force is between approximately thirty-five pounds per square inch and approximately fifteen pounds per square inch. In the illustrated embodiment, the second force may be approximately twenty pounds per square inch.

In some instances, although the flame mitigator 100 may be secured by way of its elastic material properties, the projection 132 may be further fastened (e.g., welded or otherwise affixed) to the lower annular groove 54A, 54B, 54C and/or another portion of the container 10, 10’, spout 26A, 26C, 26C, or the like to further withstand unseating of the flame mitigator 100.

Although the present disclosure has been described in detail with reference to certain example or preferred embodiments, variations and modifications exist within the scope and spirit of one or more independent aspects of the disclosure as described.

Various features of the present disclosure are set forth in the following claims.

What is claimed is:

1. A flame mitigator for a container comprising:
a plurality of wire portions reticulated to define a plurality of spaces therebetween and form a body having a substantially dome-shaped profile extending along a longitudinal axis between a first end and an opposite second end;
a rim positioned adjacent the first end and defining an opening of the body, the plurality of spaces collectively providing an openness of the opening to inhibit flame propagation along a fluid stream from entering into the container;
a projection extending radially outward from the rim and defining a periphery of the body, the projection being elastically deformable and configured to deflect relative to the rim; and
a well extending radially inward and longitudinally away from the rim to the second end.

2. The flame mitigator of claim 1, wherein the openness is between approximately forty-one (41) percent and approximately fifty-one (51) percent.

3. The flame mitigator of claim 2, wherein the openness is approximately forty-six (46) percent.

4. The flame mitigator of claim 1, wherein a major diameter measured across the periphery is greater than a minor diameter measured across the opening.

5. The flame mitigator of claim 1, wherein the body is a unitary structure configured to be inserted into a spout of the container.

6. The flame mitigator of claim 1, wherein the body includes a first surface having a concave profile and an opposite second surface having a convex profile.

7. The flame mitigator of claim 1, wherein the well is defined by a curvilinear wall having multiple distinct segments.

8. The flame mitigator of claim 1, wherein the well is defined by a wall including
a first portion that is flat and angled relative the longitudinal axis, and
a second portion that extends from the first portion and is curved at a first radius.

9. The flame mitigator of claim 8, wherein the wall further includes
a third portion that extends from the second portion and is curved at a second radius, and
a fourth portion that extends from the third portion and is flat and angled relative the longitudinal axis.

10. The flame mitigator of claim 9, wherein the first portion is angled at approximately five (5) degrees relative to the longitudinal axis and the fourth portion is angled at approximately ninety (90) degrees relative to the longitudinal axis.

11. A container comprising:
a container body including a bottom portion, a sidewall coupled to the bottom portion, and a top portion coupled to the sidewall, the bottom portion, the sidewall, and the top portion collectively defining an internal cavity configured to hold a flammable liquid;
a spout coupled to the container body in fluid communication with the internal cavity, the spout including a mouth, a stem defining a flow passage between the mouth and the internal cavity, and an annular groove extending from the stem; and
a flame mitigator positioned within the flow passage and including an elastically deformable reticular body having
a substantially dome-shaped profile formed by a plurality of intersecting wires defining a plurality of spaces therebetween configured to permit liquid flow and inhibit flame propagation into the internal cavity, and
a projection extending radially outward and received within the annular groove to mechanically couple the flame mitigator within the spout.

12. The container of claim 11, wherein the projection includes a first bevel having a first minor radius and a second bevel having a second minor radius, and wherein the second bevel contacts the annular groove.

13. The container of claim 12,
wherein the projection further includes a third bevel having a third minor radius that is less than the first minor radius and the second minor radius, and
wherein the first minor radius, the second minor radius, and the third minor radius are all less than approximately 0.060 inches.

14. The container of claim 13, wherein the first bevel, the second bevel, and the third bevel are entirely positioned within a height of approximately 0.055 inches.

15. The container of claim 11,
wherein the container body further includes a countersink portion extending therefrom and defining a constriction,
wherein the spout further includes a skirt extending from the annular groove, and
wherein the skirt and the countersink portion are coupled together to secure the spout to the container body.

16. The container of claim 15, wherein a radially interior and downwardly extending part of the skirt contacts a radially exterior and upwardly extending part of the countersink portion.

17. The container of claim 16,
wherein the flame mitigator has a major diameter measured across a periphery defined by the projection, and
wherein the constriction has a diameter less than the major diameter, such that the periphery is constricted when the flame mitigator is positioned within the spout.

18. The container of claim 11,
wherein the spout further includes a revolute flange extending longitudinally and radially away from the stem, and
wherein the revolute flange is coupled to the sidewall.

19. A method of manufacturing a container comprising:
providing a container body including a bottom portion, a sidewall portion, and a top portion, the top portion including an upper side exposed to an exterior of the container and an opposite lower side;
positioning a spout on the upper side of the top portion, the spout including a stem, a mouth adjacent a first end of the stem, and an annular groove adjacent a second end of the stem opposite the first end;
pressing, by a tool, a flame mitigator into the annular groove of the spout to mechanically couple the flame mitigator to the spout, the flame mitigator being elastically deformable and including a substantially dome-shaped profile, wherein a portion of the flame mitigator is deflected radially inwardly as the flame mitigator is pressed into the annular groove by the tool.

20. The method of claim 19,
wherein flame mitigator includes a well, a rim extending from the well, and a projection extending radially away from the rim, and
wherein pressing the flame mitigator into the annular groove includes contacting the well but not the projection or the rim with the tool.
